(19) United States
(12) Patent Application Publication
(10) Pub. No.: US 2008/0126808 A1
(43) Pub. Date: May 29, 2008

(54) Encrypted dataset access by custodians

(75) Inventors: William Pat Price, Santa Ana, CA (US); Gary William Streuter, Newport Beach, CA (US); James Sedin, Ketchum, ID (US)

Correspondence Address: FISH & RICHARDSON, PC, P.O. BOX 1022, MINNEAPOLIS, MN, 55440-1022, US

(73) Assignee: CMS PRODUCTS, INC.

(21) Appl. No.: 11/773,288

(22) Filed: Jul. 3, 2007

Related U.S. Application Data
(60) Provisional application No. 60/818,353, filed on Jul. 5, 2006.

(51) Int. Cl. H04L 9/32

(52) U.S. Cl. 713/183

(57) ABSTRACT

Management of encrypted datasets residing on magnetic or optical media. Current data encryption products typically allow a primary user to enter a code such as a password or pass phrase prior to the encryption of a set of data. The password or phrase is used by the encryption/decryption software to generate or create the user's key when they wish to decrypt the dataset. The issue addressed by this invention occurs when the primary user is not available to enter the password or pass phrase. The present invention allows for the creation of two or more additional key sets, called custodial keys, which when used in unison or in predefined combinations of keys, will allow access to the encrypted dataset.

### CROSS-REFERENCE TO RELATED APPLICATIONS

This application claims priority to U.S. Provisional Application 60/818,353, filed Jul. 5, 2006. The disclosure of the prior applications are considered part of (and are incorporated by reference in) the disclosure of this application.

### BACKGROUND

The protection of sensitive data has become a major concern to both the business community and to government entities. The US Government and others have certified a particular encryption/decryption algorithm for use in protecting sensitive and confidential data. Specifically, the AES (Advanced Encryption Standard) algorithm for use in securing both business and classified data had been the choice of many. This algorithm encrypts and decrypts Datasets with key sizes of 128 bits and 256 bits, with the larger size being more secure. This standard is outlined in US Government Publication 197, known as the Federal Information Processing Standard or FIPS. The need for even greater data security will in all likelihood spawn even higher levels of data encryption in the future.

Software programs managing the encryption and decryption processes will typically ask the user or owner of encrypted datasets for a password or passphrase with some minimum number of characters.

The strong encryption techniques available today can cause a great deal of concern to the rightful owners of data included within an encrypted dataset. If the primary user of the encrypted dataset is not present, is unable or is unwilling to provide the primary password necessary to decrypt the dataset, then access to the encrypted dataset by the rightful owners of the data is not possible. The use of custodial passwords for access to encrypted Datasets insures that the rightful owner or governing agency has a secure overriding access method to decrypt and recover the data contained within an encrypted dataset.

Recent news headlines have been filled with many instances concerning the loss of data on lost or stolen computers and storage devices. In the vast majority of these cases, the lost or stolen data was not present in an encrypted format, and was thus usable by unauthorized users. A solution to this problem might be to require encryption of all data.

### SUMMARY

Techniques for managing manage access to encrypted datasets are disclosed. Custodial access is allowed through the use of two or more secondary passwords.

An embodiment captures a plurality of passwords from a primary user and from designated custodians. The embodiment may then encrypt the dataset encryption key into a dataset that is algorithmically merged into the encrypted dataset.

If the user or owner of the encrypted dataset is not present, the embodiment may have capability to permit the designated custodians to enter their passwords into the decryption application to decrypt the encrypted dataset.

### BRIEF DESCRIPTION OF THE DRAWINGS

FIG. 1 shows an Encrypted Password Dataset With 2 Encrypted Elements containing multiple encrypted copies of the dataset encryption key of which one copy of the key is encrypted with a key derived from the primary user's password and the second copy is encrypted with a key derived from all of the custodian's passwords hashed together.

FIG. 2: Encrypted Password Dataset With 4 Encrypted Elements Containing Groups Of Custodian Keys—this figure depicts a structure containing multiple encrypted copies of the dataset encryption key of which one copy of the key is encrypted with a key derived from the primary user's password and 3 copies of the dataset encryption key are encrypted with passwords derived from each combination of 2 of 3 custodians hashed together.

FIG. 3: Capture Of Primary User Authentication Data and Secondary Custodial Authentication Data And Encryption Of Data—This figure depicts the capturing of User and Custodian authentication data and the sequence of operations to encrypt a clear text Dataset into an encrypted Dataset containing the user/custodian authentication data.

FIG. 4: Decryption Of Data Using Primary User/Owner Password—this figure depicts the decryption of an encrypted dataset after capture of the primary user's password and decryption of the encrypted dataset encryption key.

FIG. 5: Decryption of Data Using Secondary Custodian Authentication Data—this figure depicts the decryption of an encrypted dataset after capture of the custodians password and decryption of the encrypted dataset encryption key.

FIG. 6: Relationship of the Primary User And Custodians For Entering Passwords For Decryption Of Encrypted Datasets—this figure depicts the ability of either the primary user or the secondary custodians but not both at the same time to enter passwords to allow the decryption process to start.

FIG. 7: Relationship Of The Primary User Or Any 2 of 3 Custodians for Entering Password For Decryption Of Encrypted Datasets—this figure depicts the ability of either the primary user or the any 2 of the secondary custodians but not both at the same time to enter passwords to allow the decryption process to start.

### DETAILED DESCRIPTION

The inventors recognized that current encryption schemes typically only allow access to encrypted data via the primary user's authorization code. This presents a dilemma to the rightful owner of the encrypted data if they are other than the primary user.

An example of this problem for the rightful owner of encrypted data comes when backing up a system's data to external media for archiving. The rightful owner of the encrypted data may not have the codes for decrypting the data without the co-operation of the primary user. Consider the case of a corporation which backs up data on remote employee's systems to local storage devices. In this example, the corporation owns the data, but the employee, the primary user, is the only one who has access to the data.

In recognition of this problem, the present application describes embodiments which enable providing access to multiple different users. In the example given above, the corporation which owns this data can elect to create two custodial keys during the encryption process. The local employee would also create a primary authorization code. All codes are assigned to the encrypted data. The corporation would have the ability to decrypt the dataset by entering two or more of the secondary custodial passwords assigned to that dataset if the employee is unavailable or unwilling to cooperate in decrypting the data. That has never been 's

In this disclosure, the term “custodian” refers to secondary passwords which are given access to an encrypted dataset without the primary user's password. In embodiments, it may be necessary to obtain multiple custodian passwords.

The embodiments described herein describe operations that can be carried out in dedicated logic, or reconfigurable logic such as FPGAs or a DSP or in software, or in any other way.

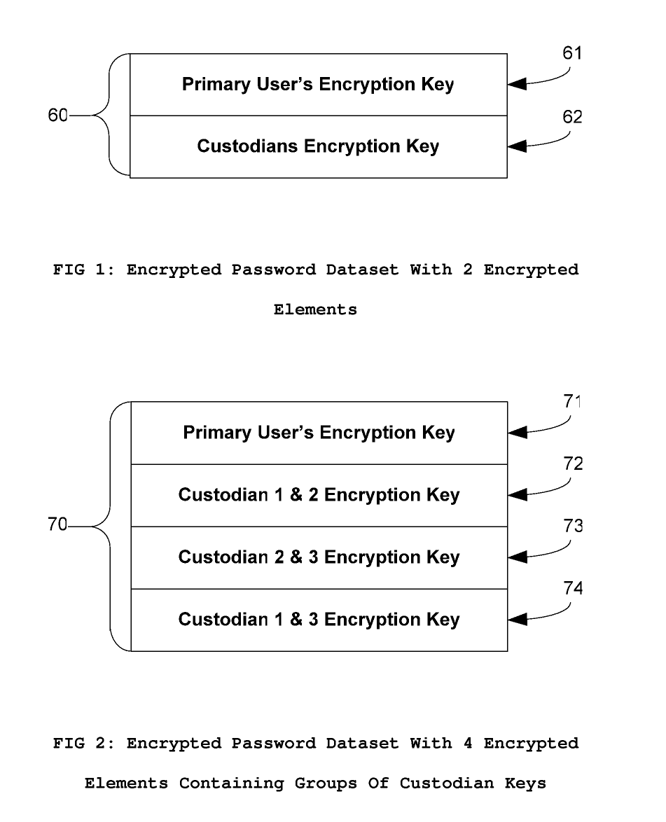

FIGS. 1 and 2 show first relationships between passwords and custodian passwords in a structured arrangement. FIG. 1 shows an Encrypted Password Dataset 60, having two elements including a Primary User's Encryption Key 61 and a Custodian's Encryption Key 62. Any given element of any of the structures contains an encryption key used to encrypt a dataset. All of the encryption keys in the same structure are the copies of each other. The encryption key in each element of the structures is itself encrypted with an encryption key derived from a hashed string of alphanumeric characters. The string of alphanumeric characters is derived from either the password used by the primary user; or a plurality of passwords from the custodians passwords that have been merged together. Hashing of the passwords is performed so that a third party attempting to decrypt the structure with a software program that does not know the hashing algorithm could not attempt to decrypt the structure using clear text passwords that were themselves not hashed.

FIG. 1 shows the Encrypted Password Dataset 60 comprised of Primary User's Encryption Key 61 and Custodians Encryption Key 62. Each element of Encrypted Password Dataset 60 holds a common copy of the encryption key used to encrypt the dataset. The first element, Primary User's Encryption Key 61, is encrypted with an encryption key derived from the Primary User's password. The second element of Encrypted Password Dataset 60 is Custodians Encryption Key 62 which is derived from a plurality of Custodial Passwords 1 through n, where n is equal to 2 or more.

FIG. 2 shows the encrypted Password Dataset comprised of Primary User's Encryption Key 71 and three elements formed of a first set of Custodian 1 & 2 Encryption Key 72, a second set formed of custodian 2 & 3 Encryption Key 73, and a third set formed of Custodian 1 & 3 Encryption Key 74. These 3 elements comprise all of the possible two-element combinations of 3 custodians. Any 2 of the 3 can access the encrypted dataset. Each of the 3 elements containing custodian encryption keys is itself encrypted with a key derived from 2 of the 3 Custodians Passwords merged together.

The sets of Secondary Custodians are labeled Secondary Custodian 1, Secondary Custodian 2, . . . Secondary Custodian n. This is intended to show that the plurality of Secondary Custodians are a minimum of two and a maximum of ‘n’ where ‘n’ is an integer number greater than 2.

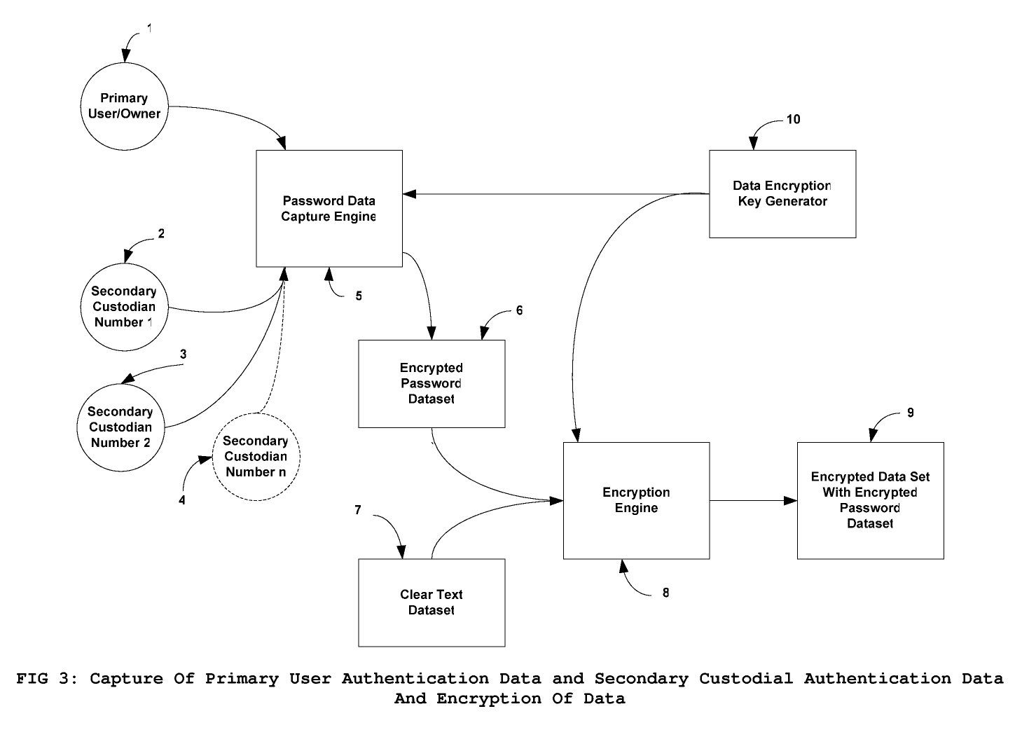

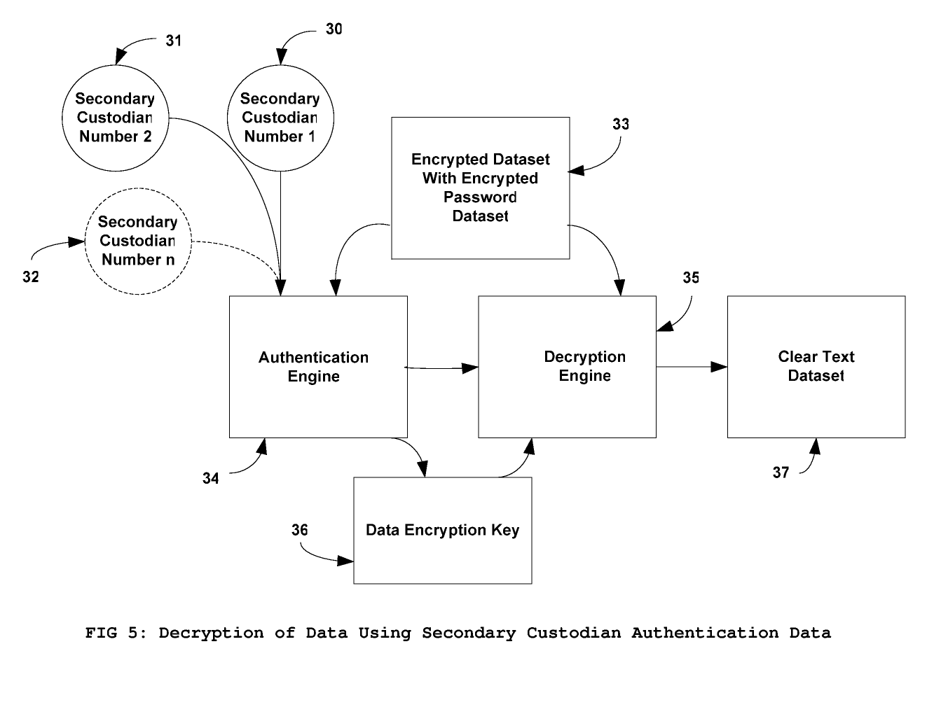

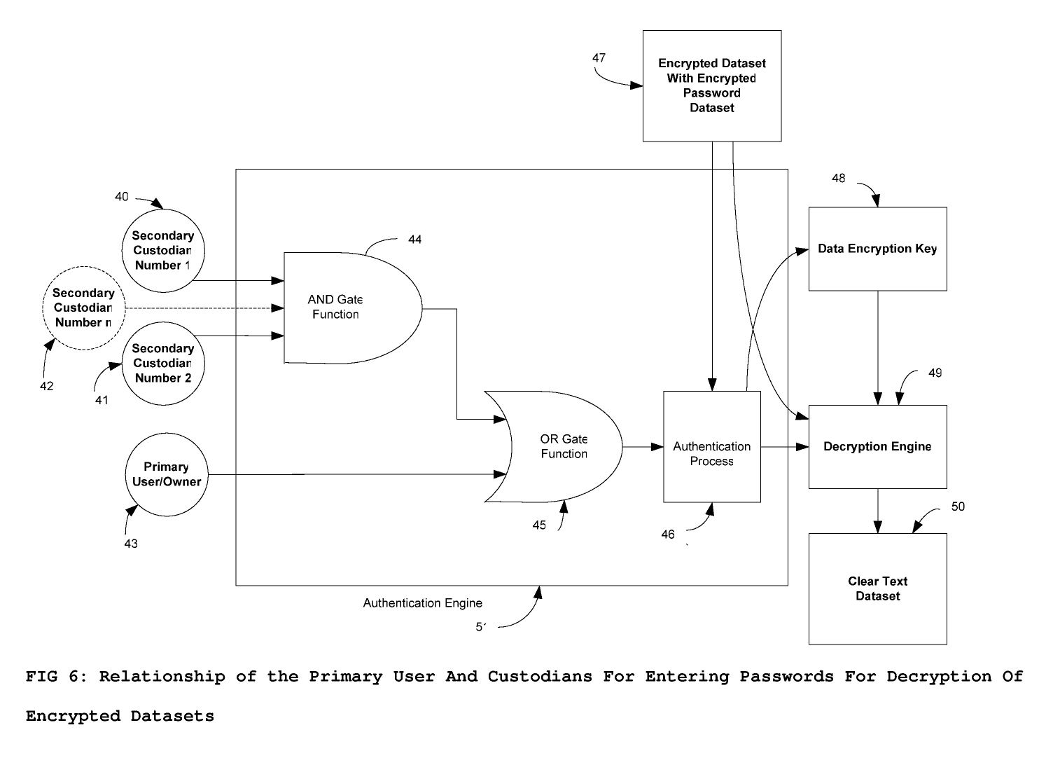

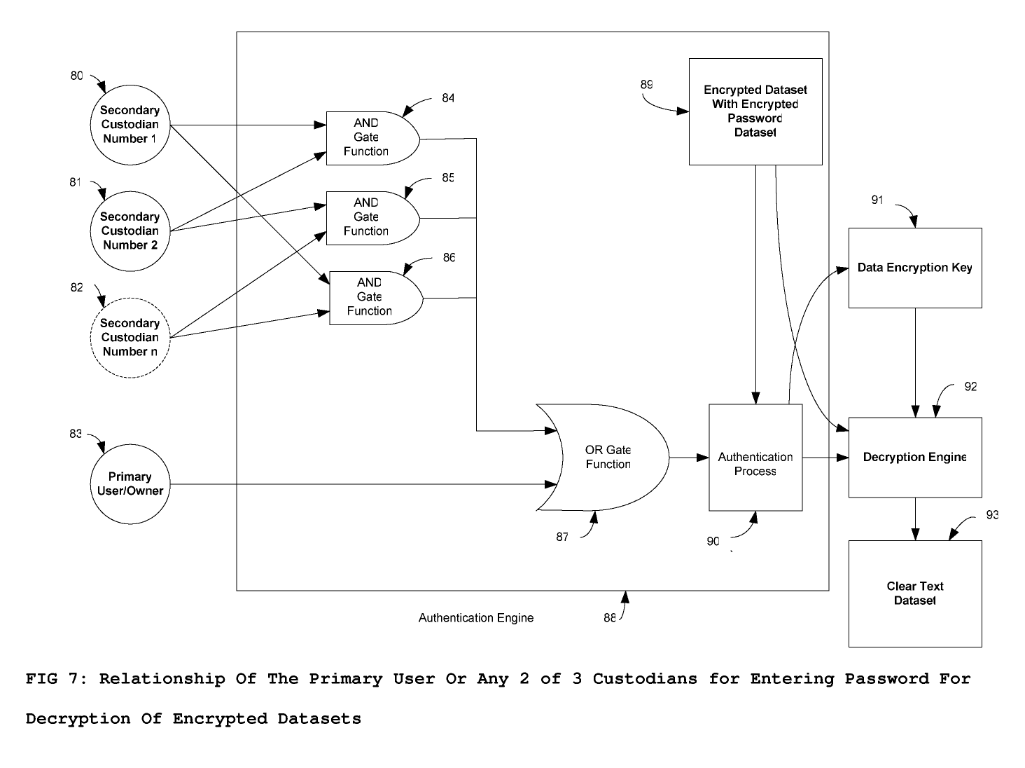

FIG. 3 shows the Secondary Custodians are 2, 3, and 4. FIG. 5 shows the Secondary Custodians are 30, 31, and 32. FIG. 6 shows the Secondary Custodians are 40, 41, and 42. FIG. 7 shows the Secondary Custodians are 80, 81, and 82.

FIG. 3 illustrates the Password Data Capture Engine 5 that captures password data provided by the Primary User/Owner 1 and by a plurality of Secondary Custodians 2, 3 and 4. Data and the dataset encryption keys are generated by Data Encryption Key Generator 10 and used by Password Data Capture Engine 5 to produce Encrypted Password Dataset 6, which can include, for example, 60 or 70, as depicted in FIGS. 1 and 2.

Encryption Engine 8 encrypts Clear Text Dataset 7 using the same encryption key generated by Data Encryption Key Generator 10 and given to Password Data Capture Engine 5. Encryption Engine 8 encrypts the Clear Text Dataset 7 and merges it with Encrypted Password Dataset 6, to produce an encrypted Dataset With Encrypted Password Dataset 9.

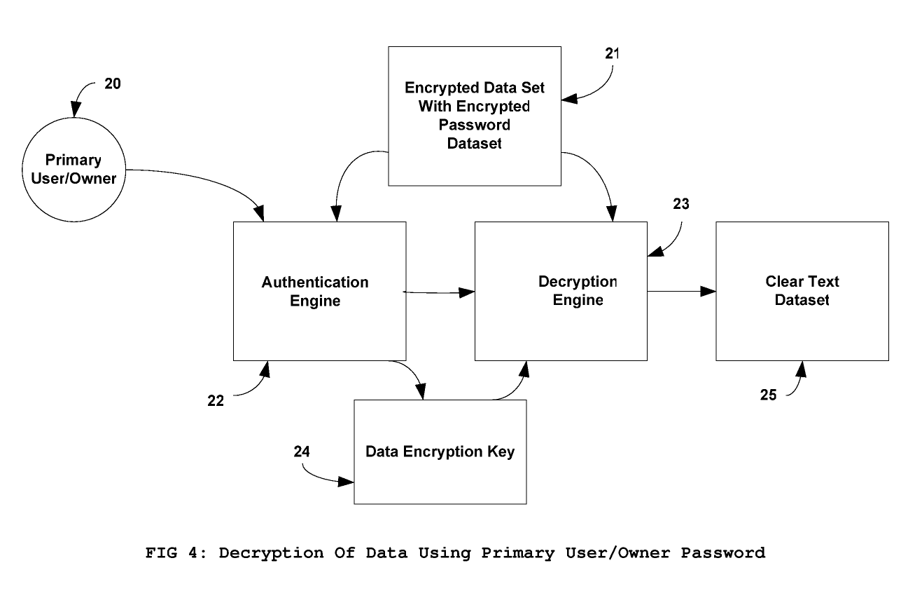

Now referencing FIG. 4, Authentication Engine 22 captures a password from Primary User/Owner 20 and hashes the password. Authentication Engine 22 then algorithmically extracts Encrypted Password Dataset 60 or 70 as depicted in FIGS. 1 and 2 and, using the hashed password, decrypts and produces Data Encryption Key 24. Authentication Engine 22 then notifies Decryption Engine 23 that it can decrypt Encrypted Dataset With Encrypted Password Dataset 21. Decryption Engine 23 then uses Data Encryption Key 24 to decrypt Encrypted Dataset With Encrypted Password Dataset 21 producing Clear Text Dataset 25.

FIG. 5 shows Authentication Engine 34 which captures passwords from the pre-determined number of Secondary Custodians 30, 31, and 32. If the encrypted password dataset structure contained in Encrypted Dataset With Encrypted Password Dataset 33 is the same as that depicted in FIG. 1 Encrypted Password Dataset 60, the Custodian passwords are captured by Authentication Engine 34. These passwords are then hashed together and used to decrypt Data Encryption Key 36 from Encrypted Dataset With encrypted Password Dataset 33.

If encrypted password dataset structure contained in Encrypted Dataset With encrypted Password Dataset 33 is the same as that depicted in FIG. 2 Encrypted Password Dataset 70, then the Custodian passwords captured by Authentication Engine 34 are hashed together in all 3 possible combinations. Each combination is used to attempt to decrypt Data Encryption Key 36 from Encrypted Dataset With encrypted Password Dataset 33. If successful, Authentication Engine 34 notifies Decryption Engine 35 that it can decrypt Encrypted Dataset With Encrypted Password Dataset 33. Decryption Engine 35 then uses Data Encryption Key 36 to decrypt Encrypted Dataset With Encrypted Password Dataset 33 producing Clear Text Dataset 37.

FIG. 6 shows Authentication Engine 51 functionally including two logic gates defining an AND Gate Function 44, and an OR Gate Function 45. A process function Authentication Process 46 receives the results.

Different combinations can be used. According to a first combination, all of Secondary Custodian 1 40, Secondary Custodian 2 41, and Secondary Custodian n 42 are to be used for providing passwords. The AND Gate Function 44 requires all three of these passwords to be present, either simultaneously, or at different times. The authentication data entries by the Secondary Custodians 40, 41, and 42 can be received, for example, by three persons Secondary Custodians in a serial fashion, that is, one after another. The and gate 44 may have a sample and hold device or other kind of latch, incorporated therein.

Once password data has been entered by all the Secondary Custodians 40, 41, and 42, a signal is sent to the “OR” gate 45.

OR Gate Function 45 accepts as password data, when information has been entered by either the Primary User/Owner 43 or by all three of the Secondary Custodians 40, 41, and 42. When either of those conditions has been met, OR Gate Function 45 notifies Authentication Process 46 that passwords have been entered. Authentication Process 46 then extracts and decrypts Data Decryption Key 48 from Encrypted Dataset With Encryption Password Dataset 47. Authentication Process 46 then notifies Decryption Engine 49 that Data Encryption Key 48 is present.

Once the notification has been made, Decryption Engine 49 decrypts Clear Text Dataset 50 from Encrypted Dataset With Encryption Password Dataset 47 using Data Encryption Key 48.

FIG. 7 shows an alternative Authentication Engine 88, which allows authentication by any 2 of the three custodians. Three logic AND gates 84, 85 and 86, and one OR Gate 87 carry out the authentication Process. If any 2 of the 3 shown Secondary Custodians 80, 81, 82 enter their passwords, then the corresponding AND gates provides a signal indicative of true notification to Or Gate 87. There are 3 possible combinations of the Secondary Custodians 80, 81 and 82. A first is Secondary Custodian Number 1 80 and Secondary Custodian Number 2 81 causing And Gate Function 84 to provide a true indication to Or Gate Function 87. A second is Secondary Custodian Number 1 80 and Secondary Custodian Number n 82 causing And Gate Function 86 to provide a true indication to Or Gate Function 87. A third is Secondary Custodian Number 2 81 and Secondary Custodian Number n 82 causing And Gate Function 85 to provide a true indication to Or Gate Function 87.

As in the above, the gates can have sample and hold type functionality that enables the required any two of three of the Secondary Custodians to be provided at different times. This enables the authentication data entries by the Secondary Custodians 80, 81, and 82 to be carried out by any two of three persons who make up the group collectively referred to as the Secondary Custodians in a serial fashion, that is, one after another. The logical ‘AND’ functionality of AND Gate Function 84 prevents the AND Gate 84 from notifying OR Gate 87 that password data has been entered by Secondary Custodians 80 and 82 until both of the Secondary Custodians 80 and 82 have entered their respective data. The same holds true for the other two And Gate Functions 85 and 86.

OR Gate Function 87 accepts password data when it has been entered by either 1 the Primary User/Owner 83 or 2 any two of three of the Secondary Custodians 80, 81, and 82. When either of those conditions has been met, OR Gate Function 87 notifies Authentication Process 90 that passwords have been entered. Authentication Process 90 then extracts and decrypts Data Decryption Key 91 from Encrypted Dataset With Encryption Password Dataset 89. Authentication Process 90 then notifies Decryption Engine 92 that Data Encryption Key 91 is present. Decryption Engine 92 then decrypts Clear Text Dataset 93 from Encrypted Dataset With Encryption Password Dataset 89 using Data Encryption Key 91.

The general structure and techniques, and more specific embodiments which can be used to effect different ways of carrying out the more general goals are described herein.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, the above describes n custodians, and accepting 2 of the n as being a valid password. However, any number can be used; for example 3 or 4 custodians, 2 or 4 or 5 custodians, or any other number.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computing structure described herein may be any kind of logic gates, computer, either general purpose, or some specific purpose computer such as a workstation. The computer may be an Intel (e.g., Pentium or Core 2 duo) or AMD based computer, running Windows XP or Linux, or may be a Macintosh computer. The computer may also be a handheld computer, such as a PDA, cellphone, or laptop.

Programs for these computers or gates may be written in C or Python, or Java, Brew or any other programming language. The programs may be resident on a storage medium, e.g., magnetic or optical, e.g. the computer hard drive, a removable disk or media such as a memory stick or SD media, wired or wireless network based or Bluetooth based Network Attached Storage (NAS), or other removable medium. or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. A method comprising:
accepting entry of plural different passwords; and responsive to first receiving a password of the primary user, decrypting first information associated with said primary user; and
responsive to second receiving multiple passwords of multiple different secondary users, decrypting the same said first information associated with the primary user, wherein said second entering requires that multiple passwords be received prior to said decrypting.

2. A method as in claim 1, further comprising storing an decryption key that is changed using said passwords.

3. A method as in claim 2, wherein said decryption key includes a first decryption key for the primary user, that is changed using the primary user's password, and a second decryption key for the secondary users, where the decryption key is changed according to multiple different combinations of multiple different secondary user passwords.

4. A method as in claim 3, wherein there are at least three different secondary users, and said changing includes encrypting, and said multiple different combinations include a first key encrypted using both a first and second user password, a second key encrypted using both a second and third user password, and a third key encrypted using both a first and third user password.

5. A method as in claim 1, wherein said second entering comprises entering said multiple passwords at different times.

6. A method as in claim 3, wherein said changed decryption key is encrypted using said passwords.

7. A method as in claim 1, wherein said second entering comprises responsively allowing said decrypting when fewer than all of the possible secondary passwords are entered.

8. A method as in claim 7, wherein said second entering allows entering of N different passwords, and allows said decrypting when any two of the N passwords are entered.

9. A method as in claim 7, wherein said second entering allows entering of N different passwords, and allows said decrypting when N−1 of the passwords are entered.

10. A method as in claim 1, wherein said second entering comprises responsively allowing said decrypting only when all of the possible secondary passwords are entered.

11. A system comprising:
a storage part, storing at least two different decryption keys, including a first decryption key that is encrypted based on a password of a primary user, and a second decryption key that is encrypted based on multiple passwords of multiple secondary users;
a password entry part; and
a decrypting part, responsive to said password entry part, operating responsive to first receiving the password of the primary user, decrypt first information associated with said primary user, and responsive to second receiving multiple passwords of multiple different secondary users, decrypt the same said first information associated with the primary user, wherein said second receiving requires that multiple passwords be entered prior to said decrypting.

12. A system as in claim 11 wherein said decryption key includes a first decryption key for the primary user, that is changed using the primary user's password, and a second decryption key for the secondary users, where the decryption key is changed according to multiple different combinations of multiple different secondary user passwords.

13. A system as in claim 12, wherein there are at least three different secondary users, and said multiple different combinations include a first key that is encrypted using both a first and second user password, a second key encrypted using both a second and third user password, and a third key encrypted using both first and third user password.

14. A system as in claim 12, wherein said password entry part includes a storage part that stores passwords, enabling said multiple passwords to be entered at different times.

15. A system as in claim 13, wherein said decrypting part accepts N passwords and carries out decrypting when fewer than all of the possible secondary passwords are entered.

16. A system as in claim 15, wherein said decrypting part accepts N passwords and carries out decrypting when any two of the N passwords are entered.

17. A system as in claim 15, wherein said decrypting part accepts N different passwords, and allows said decrypting when N−1 of the passwords are entered.

18. A system as in claim 11, wherein said decrypting part allows decrypting only when all of the possible secondary passwords are entered.

19. A method comprising:
encrypting a collection of data by an encryption engine with an encryption key;
maintaining multiple copies of said encryption key, where at least plural copies of said decryption key are each encrypted with a unique encryption key, one of said copies being encrypted using an encryption key derived from a primary user's password, others of said copies being encrypted using an encryption key derived from passwords of two or more secondary users;
using the primary user's password to decrypt the copy encrypted with said user's password thereby deriving a dataset encryption key contained in said copy and using said dataset encryption key to decrypt at least a part of said collection of information;
using plural of the secondary user's passwords together, to decrypt the copy encrypted with said secondary user's passwords thereby deriving a second dataset encryption key contained in said element and using said second dataset encryption key to decrypt at least a part of said collection of information.

20. The method of claim 19 whereby the inclusion of the custodial passwords in the encryption process may be included prior to, or during the creation of an encrypted dataset.

21. The method of claim 19 whereby the application of passwords for said secondary users in the encryption process, after the initial creation of an encrypted dataset, requires the submission of the primary user's password prior to allowing the inclusion of the secondary user passwords.

22. The method of claim 19 whereby the secondary passwords are used to create a symmetrical key which is used to encrypt the database key.

23. The method of claim 19 whereby the secondary passwords are used to create a non-symmetrical key which is used to encrypt the dataset key.

24. The method of claim 1 whereby the secondary passwords may include a selection of security questions, which when answered correctly, simulate the insertion of the custodial password, to which the security questions are attached.
